(19) United States
(12) Patent Application Publication
(10) Pub. No.: US 2025/0342825 A1
(43) Pub. Date: Nov. 6, 2025

(54) AI-POWERED ADD-ON MODULAR CONTROLLERS FOR AUTONOMOUS VEHICLES

(71) Applicants: Mokhles M. Abdulghani, Jackson, MS (US); Wilbur L. Walters, Jackson, MS (US); Khalid H. Abed, Jackson, MS (US)

(72) Inventors: Mokhles M. Abdulghani, Jackson, MS (US); Wilbur L. Walters, Jackson, MS (US); Khalid H. Abed, Jackson, MS (US)

(21) Appl. No.: 19/200,378

(22) Filed: May 6, 2025

Related U.S. Application Data
(63) Continuation-in-part of application No. 18/656,193, filed on May 6, 2024.

(51) Int. Cl. G10L 15/08; G10L 15/02; G10L 15/20; G10L 15/28; G10L 25/48

(52) U.S. Cl. CPC G10L 15/083; G10L 15/02; G10L 15/20; G10L 15/28; G10L 25/48

(57) ABSTRACT

The present disclosure relates to methods and apparatuses for classifying internalized speech. In particular, disclosed herein is a method for interpreting electrocardiogram (ECR) and electroencephalogram (EEG) signals in an individual using electrodes placed on the individual's skin. The method disclosed herein may be performed using a low-cost, low-channel ECG apparatus, such as by placing three sensors on the individual's skin and which may be wearable and portable to facilitate its use and with an eight-channel EEG apparatus, such as by placing sensors on the individual's head. The sensors may be placed on the left and right sides of the individual's forehead and on the left side below the individual's neck to collect ECG signals, although other placements are possible. Autoregressive coefficient (AR), Shannon entropy, fractal measures, and multiscale wavelet variance estimation may then be applied to the collected signals to determine the individual's internalized speech.

### CROSS-REFERENCE TO RELATED APPLICATION

The present application is a continuation-in-part of U.S. patent application Ser. No. 18/656,193, filed on May 6, 2024.

### BACKGROUND OF THE INVENTION

Independent transportation remains an ongoing problem for certain individuals with disabilities, including, but not limited to, individuals with conditions such as ALS, cerebral palsy, or speech disorders. As such, these individuals may be reliant on third parties for their transportation needs.

The term ‘affective’ is a psychological expression referring to the experience of human feelings and emotions. In 1995, the field of affective computing was first originated by Dr. Picard, who discussed neurological studies related to human emotions or other affective phenomena and the possibility of mimicking them with a computer using the concept of emotion recognition. The type of speech or words a person produces is essentially linked with the internal affections or emotional experience that person is going through. As a result, recent studies on determining intended expression have focused on processing physiological signals in a multimodal approach by combining different types of physiological signals such as electroencephalogram (EEG), electromyogram (EMG), galvanic skin response (GSR), blood volume pressure (BVP), photoplethysmography (PPG), or electrocardiogram (ECG).

An enormous body of research has been conducted aiming to convert human brain signals to speech. Although experiments have shown that the excitation of the central motor cortex is elevated when visual and auditory cues are employed, the functional benefit of such a method is limited. Imagined speech, sometimes called inner speech, is an option for decoding human thinking using the brain-computer interface (BCI) concept. BCI is being developed to progressively allow paralyzed patients to interact directly with their environment. Brain signals usable with the BCI systems can be recorded with a variety of common recording technologies, such as magnetoencephalography (MEG), electrocorticography (ECOG), functional magnetic resonance imaging (fMRI), functional near-infrared spectroscopy (fNIRS), and electroencephalography (EEG). EEG headsets are used to record the electrical activities of the human brain. EEG-based BCI systems can convert the electrical activities of the human brain into commands.

Similarly, research has revealed that the heart is the most potent source of the electrical field in the human body. The amplitude of the electrical field generated by the heart can be 60 times higher than the electrical field generated by the brain. In addition, they stated that the nervous system acts as an antenna that responds and tunes to the magnetic fields generated by the heart. More research to enhance this energetic communication ability can result in a much deeper level of non-verbal communication between people, such as inner speech. The electrical field generated by the heart is monitored and measured through a process called electrocardiography which records it in an ECG graph illustrating the variation in voltage versus time. ECG electrodes can be placed anywhere on the body's surface, capturing the dynamic response of the autonomic nervous system towards each emotion which is reflected as rhythmic fluctuation in the heart, and it can be recorded using a less mobile, intrusive, and wearable device. No study, however, has been published wherein there was an attempt to study or classify inner speech, imagined speech, or human thinking in general based on ECG alone in a unimodal approach (i.e., using a single type of signal).

Although some studies have focused on EEG alone, such studies thus far have tended to suffer from poor accuracy and/or require the use of high-cost, high-channel headsets. Similarly, no studies have attempted to study or classify inner speech, imagined speech, or human thinking in general based on ECG. As such, a low-cost, high-accuracy EEG and/or ECG solution would serve unmet needs for individuals with disabilities who seek transportation independence.

### SUMMARY OF THE INVENTION

In some embodiments, the present disclosure describes an internalized speech recognition method using at least one signal comprising the steps of: placing at least one electrode on an individual; collecting data from the individual using the at least one electrode; preprocessing the collected data, wherein the preprocessing comprises noise attenuation and calibration; extracting features from the collected data using at least one feature extraction method; and classifying the features using supervised learning using a machine learning algorithm.

In some embodiments of the method, the data is EEG data and the noise attenuation and calibration comprises the step of applying a bandpass filter between 10 and 100 Hz to eliminate noise.

In some embodiments, the data is ECG data and the noise attenuation and calibration comprises the steps of applying a 4th order Butterworth bandpass filter with 0.5 Hz to 150 Hz bandwidth, applying a notch filter at 60 Hz, and applying a high-pass filter with a cut-off frequency of 0.5 Hz.

In some embodiments, the method further comprises presenting an audio or visual prompt to the individual prior to collecting data.

In some embodiments, the electrodes are placed on the left side of the individual's forehead, the right side of the individual's forehead, and on the individual's left side below the neck.

In some embodiments, the at least one feature extraction method is selected from the group consisting of: autoregressive coefficient (AR), Shannon entropy, fractal measures, and multiscale wavelet variance estimation. In some embodiments, the machine learning algorithm is SVM.

In some embodiments, the individual has been diagnosed with or suspected of having a speech disorder.

In some embodiments, the features are classified using a predetermined set of words.

In some embodiments, the method comprises an additional step of controlling a vehicle using the classified features.

In some embodiments, the present disclosure describes an internalized speech recognition method using at least one signal comprising the steps of: placing at least one electrode on an individual; collecting data from the individual using the at least one electrode; preprocessing the collected data, wherein the preprocessing comprises noise attenuation and calibration; extracting features from the collected data using at least one feature extraction method, wherein the at least one feature extraction method is selected from the group consisting of: autoregressive coefficient (AR), Shannon entropy, fractal measures, and multiscale wavelet variance estimation; and classifying the features using supervised learning using a machine learning algorithm, wherein the machine learning algorithm is SVM.

In some embodiments, the present disclosure describes an internalized speech recognition method using a multimodal signal comprising the steps of: placing at least one electrode on an individual; collecting data from the individual using the at least one electrode, wherein the collected data comprises ECG data and EEG data; preprocessing the collected data, wherein the preprocessing comprises noise attenuation and calibration; extracting features from the collected data using at least one feature extraction method, wherein the at least one feature extraction method is selected from the group consisting of: autoregressive coefficient (AR), Shannon entropy, fractal measures, and multiscale wavelet variance estimation; and classifying the features using supervised learning using a machine learning algorithm, wherein the machine learning algorithm is SVM.

In some embodiments, the individual has been diagnosed with or suspected of having a speech disorder. In some embodiments, the speech disorder is mutism. In some embodiments, the individual has a disability that prevents or inhibits coherent speech. Alternatively, the individual may not speak a particular language. In some embodiments, the individual has a disability that prevents or inhibits physical movement.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 depicts recording and signal processing procedures.

FIG. 2 depicts a sample of the recorded 8-channel raw EEG signals (250 samples per second).

FIG. 3 depicts an eight-channel normalized EEG dataset at 250 Hz (250 samples per second).

FIG. 4 depicts an overview of an embodiment of an HCI system for inner speech classification.

FIG. 5 depicts an embodiment of a method to collect ECG data.

FIG. 6 depicts a sample ECG recording with the obtained representation after using AR coefficients (feature 1-4), SE (feature 5-20), fractal estimates (feature 21-22), and MWV (feature 23-32).

FIG. 7 depicts a boxplot showing a sample of the variance between each class using the extracted features.

FIG. 8 depicts spectrograms of voice commands.

FIG. 9 depicts the application of zero-padding to the beginning and end of an audio signal so that the padded signal has the same length as the original signal and ready to be used an input for CNN layers.

FIG. 10 depicts a sample signal of the recorded data used to train the voice signature recognition algorithm.

FIG. 11 depicts a triangular overlapping window (w) with L=N+1, where w{n} is the speech sample in the frame and N is a positive integer representing the number of samples in each frame.

FIG. 12 depicts filter banks on Mel frequency scale.

FIG. 13 depicts the architecture of the speaker identity verification model.

### DETAILED DESCRIPTION

The present disclosure relates to methods and apparatuses for classifying internalized speech. In particular, disclosed herein is a method for interpreting electrocardiogram (ECR) and electroencephalogram (EEG) signals in an individual using electrodes placed on the individual's skin. The method disclosed herein may be performed using a low-cost, low-channel ECG apparatus, such as by placing three sensors on the individual's skin and which may be wearable and portable to facilitate its use and with an eight-channel EEG apparatus, such as by placing sensors on the individual's head. The sensors may be placed on the left and right sides of the individual's forehead and on the left side below the individual's neck to collect ECG signals, although other placements are possible. Autoregressive coefficient (AR), Shannon entropy, fractal measures, and multiscale wavelet variance estimation may then be applied to the collected signals to determine the individual's internalized speech.

The examples, applications, descriptions and content disclosed herein are exemplary and explanatory, and are non-limiting and non-restrictive in any way.

All scientific terms used herein have the same meaning as commonly used and understood by one of ordinary skill in the art. Examples, materials, methods, figures and tables are illustrative only and not intended to be limiting.

As used herein, “AR” means autoregressive coefficient.

As used herein, “AUC” means area under curve.

As used herein, “DFT” means Discrete Fourier Transformation.

As used herein, “ECG” means electrocardiogram.

As used herein, “EEG” means electroencephalogram.

As used herein, “internalized speech” means an individual's thoughts or emotions that are not expressed audibly. For example, internalized speech can include, but is not limited to, an individual's thoughts.

As used herein, “ROC” means Receiver Operating Characteristic.

As used herein, “SVM” means support vector machine.

As used herein, “vehicle” includes motor vehicles, water/sea vehicles, or space/air vehicles.

### EEG-Based Vehicles Controller Using Imagined Speech

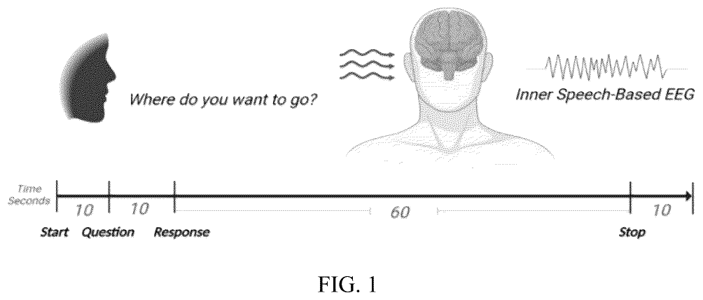

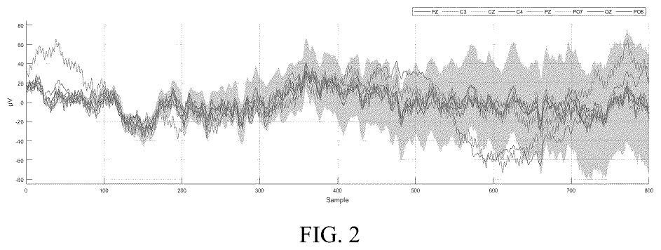

Applicants acquired a total of 400 recordings from four participants and then imported the EEG dataset into MATLAB to prepare it for processing. The EEG dataset was processed and classified together without separating them according to their corresponding participants, so that Applicants' designed algorithm could be evaluated according to its performance in dealing with a dataset from different subjects. For each command, the first 25 recordings were for subject 1, the second 25 recordings were for subject 2, and so on. After finishing the classification process, the results were labeled according to the order of the participant's dataset. FIG. 1 illustrates the recording and signal processing procedures. FIG. 2 shows a sample of the recorded 8-channel raw EEG signals. Preprocessing the raw EEG signals is essential to remove any unwanted artifacts raised from the movement of face muscles during the recording process from the scalp that could affect the accuracy of the classification process. The recorded EEG signals were analyzed using MATLAB where bandpass filter between 10 and 100 Hz was used to eliminate any noisy signals from EEG. This filtering bandwidth maintains the range frequency bands corresponding to human brain EEG frequency limit.

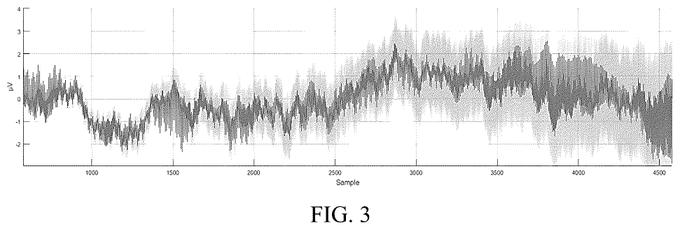

Then, normalization (vectorization) and feature extraction techniques were applied to simplify the dataset and reduce the computing power required to classify the four commands. The dataset was divided into 320 recordings and 80 recordings for the testing dataset (80% for training and 20% for testing). The EEG dataset was acquired from eight EEG sensors, and it contains different frequency bands with different amplitude ranges. Thus, it was beneficial to normalize the EEG dataset to boost the training process speed and get as many accurate results as possible. The training and testing dataset were normalized by determining the mean and standard deviation for each of the eight input signals. Then, the mean value was calculated for both the training and testing dataset. Then, the results for both were divided by the standard deviation. FIG. 3 shows a sample of the normalized EEG dataset.

The normalization and feature extraction techniques were used with both the learning and testing datasets to enhance the classification accuracy of the designed BCI system. At this point, the processed datasets were prepared to be trained in deep learning. The recorded EEG signals were pre-processed using gHIsys MATLAB toolbox (https://www.gtec.at/product/ghisys). To ensure that only the performed speech imagery data was assessed, Applicants considered removing the first and last 8 seconds of the 60 seconds in each recording. The dataset was split into 360 recordings for training and 40 recordings for testing (90% for training and 10% for testing). In an AR method of order p, the signal X{n} at time n could be represented as a linear sequence of p prior estimates of the same signal. Specifically, the AR method is modeled as:

$$X \{ n \} = {\sum }_{i = 1}^{p} a \{ i \} x ( n - i ) + e \{ n \} \qquad ( 1 )$$

where a{i} is i coefficients of the AR representation, e{n} is added noise with zero mean value, and p is the order number of the AR model. Countless methods could be used to calculate the coefficients of an AR representation. The method Applicants used to estimate the AR order in this work was the ARfit. The 1st-order was selected for the recorded EEG signals.

Shannon entropy is one of the most attractive cost functions, which is a measure of signal complexity to wavelet coefficients generated by wavelet packet transform where larger entropy values represent higher process uncertainty and, therefore, higher complexity. The representation of the Shannon entropy for the undecimated wavelet packet transform is formulated as follows:

$${SE}_{j} = {\sum }_{k = 1}^{n} {P}_{jk} log \qquad ( 2 )$$

where n is the subsequent coefficients in a j number of nodes and Pⱼₖ are the normalized squares of the wavelet packet coefficients in each node.

Wavelet variance measures the variability in EEG signal by scale or equivalently in EEG signal over octave-band frequency intervals. Applicants adjusted the vectorized data to make the number of samples in each recording in the form of (2A). The biggest number of (A) that Applicants obtained with the number of samples from each recording is 12, although higher numbers are possible. For the signal length of 8192 samples (2\hat{ }12) and using the ‘db2’ wavelet with level 5, 10 multiscale wavelet variance features were extracted from each recording using the following formula:

$$Number of Wavelet Variance = {2}^{A - db} \qquad ( 3 )$$

A total of 170 features were extracted from the EEG data: 4 per time window (1024 sample) AR coefficients, 16 per time window SE values, and 10 wavelet variance estimations. After the multi-feature extraction stage, the EEG data was reconstructed to be a 360-by-170 feature matrix for training and a 40-by-170 feature matrix for testing. By employing Autoregressive coefficients, Shannon Entropy, and multiscale wavelet variance estimates, the data were reduced from 8192 to 170 element vectors.

In the classification stage, the data were processed with supervised learning, where the specified algorithm was employed to learn from the prepared data. In this study, the classification stage was defined as the determination of four different internally spoken commands (Up, Down, Left, and Right), which are considered a multiclass classification process. SVM is one of the most well-known supervised learning algorithms specialized in classification problems. Classification using SVM is powered through generating a best line or decision boundary that segregates an n-dimension space to multiclass to easily enable data sorting to the category to which they belong. SVM works on picking the margin points that construct vectors which are called support vectors to assist with generating the best decision boundary.

The SVM architecture utilizes a set of mathematical functions that are known as the kernel functions. The kernel function performs a kind of similarity measure between input objects and transforms it into the required output. Applicants employed SVM, which is a machine learning algorithm for differentiation between the four chosen commands. Furthermore, k-fold cross-validation (k=10) was used to achieve a perfect estimate of the proposed model performance on the recorded imagined speech data and to avoid overfitting in the classification process.

The K-fold validation is an alternative to a fixed validation set. It does not affect the need for a separate held-out test set. Therefore, the data are split into training, testing and cross-validation data and is performed on folds of training sets. With k-fold cross-validation of value 10, the model performance is evaluated after dividing the data into 10 subsets (10 folds) while using the k−1 subsets for training the data. In this way, it can ensure that testing data will be entirely unknown to the classifier that is testing and training data are not coming from the same given group.

### ECG-Based Vehicles Controller Using Imagined Speech

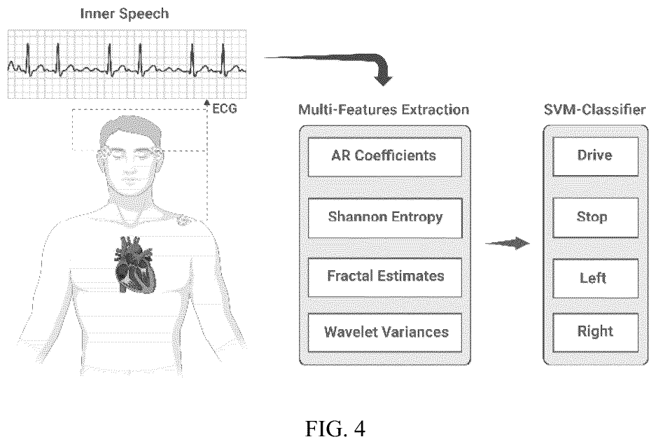

Applicants have developed methods for decoding ECG for inner speech recognition tasks to discriminate between four different internally spoken commands. Applicants refer to this technology as Heart-Computer Interface (HCI). FIG. 4 illustrates the general layout of the proposed HCI system.

The first attempt to design an HCI system was introduced for inner speech recognition. Applicants proposed a deep learning-based model used in ECG-based affective computing by applying multi-feature extraction techniques and a Support Vector Machine (SVM) classifier. The results Applicants obtained enable employing ECG in various HCI applications that can be used to improve the quality of life for a large segment of people, specifically individuals with mutism and speech disorders.

Applicants performed in-depth analyses on the ECG representations methods accompanying the deep learning process, providing a valuable insight into the impact of different features extracting techniques and their contribution towards designing an effective and robust representation of ECG. In addition, Applicants proved that the proposed multi-features extracting method using autoregressive coefficients, Shannon entropy fractal estimates, and multi-scale wavelet variance estimates results in better representations of the ECG signal compared to applying feature extracting technique using Discrete Fourier Transformation (DFT). Applicants' analysis illustrated that simplifying the ECG signal results in more efficient and proper learning of ECG representations.

Applicants obtained a state-of-the-art result for all the undertaken inner speech classification commands, namely Drive, Stop, Right, and Left recognition in the recorded datasets from ten healthy subjects. Applicants show that the ECG representations learned by the proposed model generalize very well across all merged ECG recorded sessions from all subjects, consistently resulting in accurate inner speech recognition.

Three pre-gelled disposable electrodes were used to acquire three ECG signals. These electrodes come with excellent adhesion to guarantee a good quality signal while being gentle on the skin. The flexible foam backing material for these sensors and the round shape ensure a good fit for most patients and ease the use and comfort during the signal acquisition process. The three sensors were connected to the same acquisition device using three clip-leads, 150 cm, 1.5 mm Snap-On connector. A wearable amplifier was used for acquiring the signals. This amplifier is a certified device by the Conformité Européenne (CE-certified), and the device was cleared by the United State Food and Drug Administration (FDA-cleared). The device is also capable of acquiring high-resolution physiological signals with 0.5 KHz and streaming them wirelessly to a nearby computer that can be used through the MATLAB software to visualize the acquisition in real-time. All g.tec amplifiers are designed to be connected to the input channels to enable synchronous and simultaneous recording of many electrophysiological data (including EEG, ECG, EMG, EOG, and ECOG). The computer used in this study has an AMD Ryzen 9-5950X/3.4 GHz processor, MSI GeForce RTX 3090-24 GB graphics card, CORSAIR Dominator Platinum 128 GB DDR4 memory, and Crucial P3-SSD (NVMe)-4 TB drive. A 55-inche high-resolution screen, in-ear headphones, and a car racing video game were used to generate the required auditory and video cues. The inner speech was comprised of 1760 sessions in total for all the chosen commands. In each session, the subject was seated in the chair, putting on the in-ear headphones through which the auditory cue was announced. To familiarize the participant with the experimental procedures, all experiment actions were explained before the experiment date and before signing the consent form.

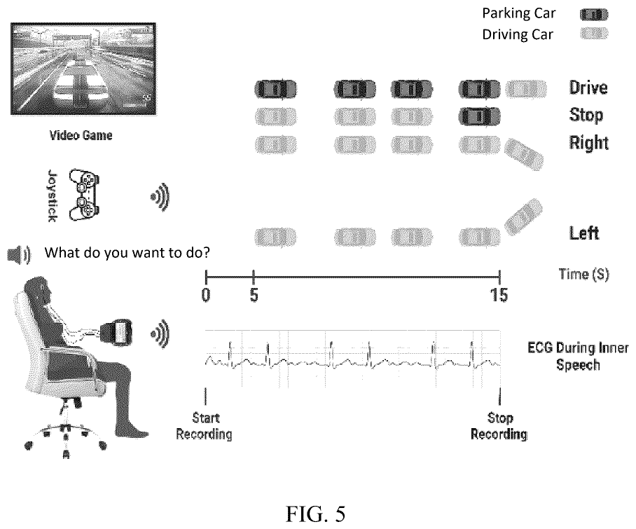

The experimental procedures were explained again during the experiment day while the ECG electrodes were placed. The setup of the electrodes and other devices took approximately 15 minutes. The participants were trained on the experiment procedure by conducting a demo session prior to the original one. Implementing a demo session was beneficial to get the subjects more adapted to the experimental procedure. In the demo session, Applicants focused on training each participant to avoid blinking, relax, take slow inhaling when starting to perform the inner speech, and try to breathe as slowly as possible until the end of the recording. Although the session time Applicants were aiming for recording is 60 s, which is the recommended time by physiologists for eliciting emotion, the demo session showed that limiting the session time to 15 s can help obtain a better-quality signal with fewer motion artifacts. Each recording took 15 s, but the first 5 s of the recording were not included in the final dataset. The first 5 s were used to allow enough time for the subject to be emotionally engaged with the visual and audio cues. Subjects were seated in high-back chairs to lessen the postural effects on the positive ECG electrodes. FIG. 5 illustrate the experimental procedure to collect the ECG data.

The total number of successfully completed recordings for each command was 440 recordings from all ten participants. The collected data was merged without separating them according to their corresponding participants. This way, Applicants can examine the performance of the proposed classification method in distinguishing between the four commands using a dataset from ten different subjects. For each command, the first 44 recordings were for S1, the second 44 recordings were for S2, the third 44 recordings were for S3, and so on, and the last 44 recordings were for S10. The recorded ECG dataset was split, labeled, stored, and prepared for the preprocessing stage. An ECG Preprocessing stage is comprised of a combination of different noise attenuation and calibration approaches to prepare the ECG signals for further analysis. The raw ECG data are prone to noises and artifacts that arise due to instrumentation, electrode placement, power line, baseline wander, subject movement, or any other disturbance. Even though ECG acquisition devices are designed to reduce power-line interference, a very small amount of external interference is expected to affect the signal. The recorded ECG signals were analyzed using gHIsys MATLAB toolbox (https://www.gtec.at/product/ghisys/accessed on Jun. 1, 2023). For the above-mentioned ECG dataset, bipolar was applied between the left forehead and right forehead electrodes where voltage differences between the left forehead, right forehead, and left below neck were obtained. A 4th order Butterworth bandpass filter with 0.5 Hz to 150 Hz bandwidth was used to attenuate the baseline drift and the noisy signals from the ECG signals. Then, a notch filter at 60 Hz (the standard power frequency in Mississippi, USA) was used to minimize the effects of power frequency. The baseline wander is normally present with frequencies below 0.05 Hz and is generally caused by respiration or perspiration of the subject, or movement, which can be attenuated using a high pass filter.

The last preprocessing technique that Applicants applied was removing the baseline wander from all the recorded datasets by applying a high-pass filter with a cut-off frequency of 0.5 Hz. Then, the filtered ECG datasets were segmented into a fixed 10 seconds (5000 samples) and stacked into an array. No further preprocessing operations were considered to avoid losing any features from the recorded ECG that can help increase the classification accuracy. The dataset was split into 1408 recordings for training and 352 recordings for testing (80% for training and 20% for testing).

Applicants performed feature extraction in the time domain to illuminate any risk of missing the dynamic changes in ECG due to the emotional status during inner speech activity. Multi-feature extraction methods were applied on one block for each recording with a time window of 10 s. Autoregressive model (AR) coefficients, Shannon Entropy (SE), fractal estimates, and multiscale wavelet variance estimates were used to extract features of the recorded data. Fractal analysis is a powerful tool for the analysis of physiological signals since it gives a description of the singular behavior of a signal. The width of the singularity spectrum in the ECG was obtained from the discreet wavelet transform leader to estimate the multifractal nature of the signal, which can be estimated as follows:

$${L}_{X} ( j , k ) = {SUP}_{∅′ ∈ ∃ ∅} ‖ {d}_{x} ( j , k ) ‖ \qquad ( 4 )$$

Where L_{X}(j,k) is the wavelet leader, SUP_{Ø∈∃Ø} are the time neighborhood parameters per sample (k+1), and dₓ is the wavelet coefficients. Then, Applicants used the 2^{nd} order scale exponents to construct the power-law behavior in the signal at different resolutions. For the ECG with a length size of 10 s, two fractal measures obtained by wavelet methods were estimated for each recording. A total of 32 features were extracted from the ECG data per time window: 4 AR coefficients per time window, 16 SE values, 2 fractal estimates, and 10 wavelet variance estimations. After the multi-feature extracting stage, the ECG data was reconstructed to be a 1408-by-29 features matrix for training and a 352-by-29 features matrix for testing. By employing Autoregressive coefficients, Shannon Entropy, fractal estimates, and multiscale wavelet variance estimates, the data was reduced from 5000 to 29 element vectors. Representation of the class variance with the extracted features from the ECG data will be reported in the final results.

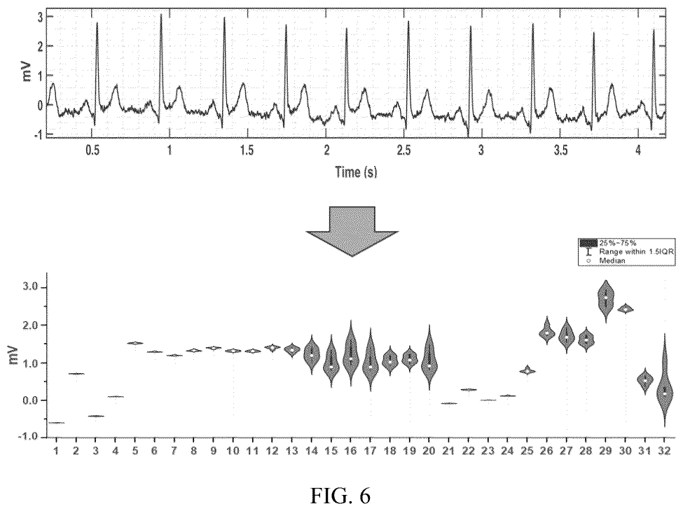

In the classification stage, the data were processed with supervised learning, where the support vector machine model was employed to learn from the prepared data. In this paper, the classification stage was defined as the determination of four different internally spoken commands (Drive, Stop, Right, and Left), which is a multi-class classification process. Applicants used a SVM, which is a machine learning algorithm for differentiation between the four chosen commands. Applicants implemented the proposed classifier using MATLAB 2023a. The model performance was evaluated after randomly selecting 20% of the data (testing data), while using the k−10 subsets for training the randomly selected 80% of the data (training data). This consideration can ensure that testing data will be entirely unknown to the classifier that is testing, and training data will not come from the same given group. FIG. 6 shows samples (for S1, the first session of performing the Drive command) and the 32 features representation obtained from each recording of it using the proposed multi-feature extraction methods. The first four features are AR coefficients, features 5 to 20 are Shannon Entropy, 21 and 22 are fractal estimates, and the last 10 features represent the multiscale wavelet variance.

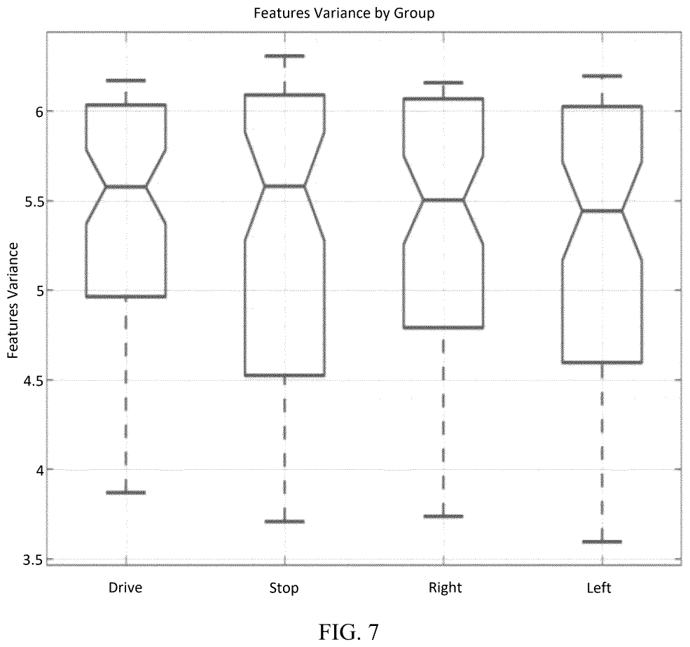

Every feature vector of the same class should be closer in its representation point, and they should be far from each other in different classes. For precisely monitoring the variance in data distribution of all features in the four classes, a boxplot was used. FIG. 7 is a boxplot for a sample of the variance between each individual command using the extracted features. The obtained results using the proposed features extraction methods showed a noticeable variation between the four commands, which accordingly will assist with distinguishing between them and improve the classification accuracy.

### Voice Recognition-Based Vehicles Controller

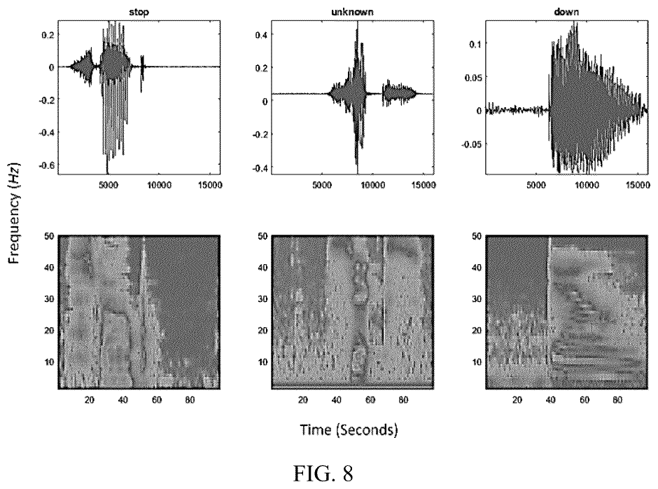

Human voice data consists of a 2500 voice audio clip for eight outspoken commands were used to train a machine learning model, which are: (on, off, go, left, right, up, down, and stop). (On and off) to switch between the drive and parking status, (go and stop) for driving forward and stopping the Vehicles, (left and right) to change direction, and (up and down) have been added as extra commands, which can be used to increase or decrease the Vehicles speed, or can be used as a safety option to control the acceleration applied on the wheels during up-hill and down-hill driving to prevent wheels' slippage. The data has been split into training and testing data (80% for training and 20% for testing). The required voice commands data has been downloaded from MATLAB 2023a audio library. All the data have been labeled, and all the other words that are not the required commands have been labeled as “Unknown”. Labeling words that are non-commands as “Unknown” creates a group of words that approximates the delivery of all words other than the commands. The networks employ this group to learn the distinction between commands and all other words. To reduce the class disparity between the “known” and the “Unknown” words, and accelerate processing, a fraction of the “Unknown” words only has been included in the training set. Background noise has been added later in a separate step to enhance the model accuracy in the real-time execution. All the training and testing voice commands, including the “Unknown”, have been converted to an auditory-based spectrogram, which is the visual representation of the audio (picture of audio) for more efficient training performance of the convolutional neural network. This has been done by splitting the audio into overlapping windows of 0.02 seconds in length and 16000 Hz frequency, performing the Short Time Fourier Transformation (STFT) on each window, and converting the resulting window to decibels. This provides us with a powerful image of the sound's shape. Finally, sending back these windows into the length of the initial voice command and presenting the output in its visual shape as shown in FIG. 8.

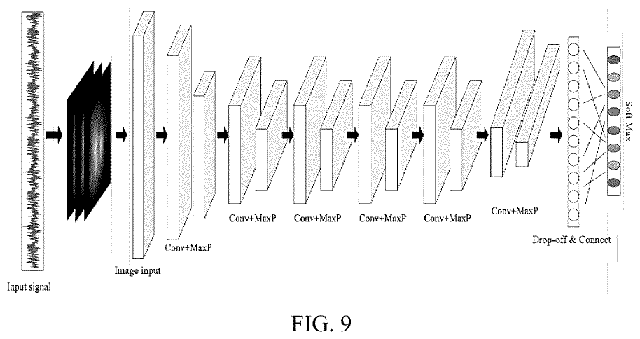

Some files in the data set are less than 1-second long, and others are more than 3 seconds, but the required input should hold a consistent size where all the data have the same length to be trained in its picture form by a CNN. Therefore, zero-padding has been applied to the beginning and end of each audio signal, so the padded signal has the same length as the original signal and ready to be used an input for the CNN layers as illustrated in FIG. 9.

L2 Regularization technique has been utilized to overcome the overfitting issue and for a smoother training process. This technique works on improving the calculation for the weights to reduce the loss function E (0) and to reduce overfitting.

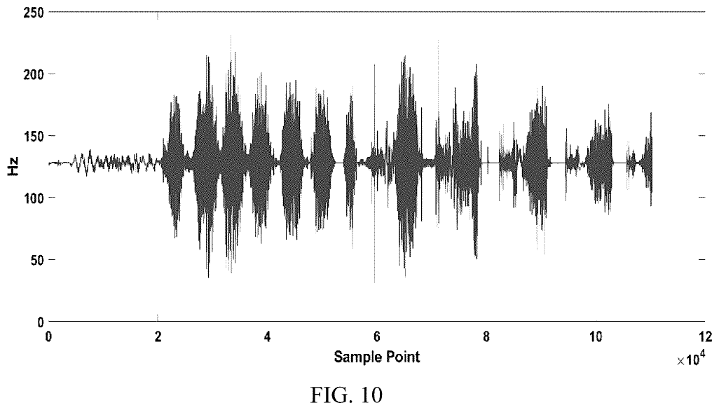

To protect the identity of the speaker and for safe Vehicles navigation using the voice, a speaker identification verification algorithm was designed. The speech signal was recorded at 22050 Hz for 20 seconds stored as a 44100-sample vector. Based on observation, the actual uttered speech, rejecting the static portions, ended to about 11800 samples. Each of the eight commands (On, Off, Go, Left, Right, Up, Down, Stop) was repeated 3 times during the 20-second recordings. To get better trainable data, male and female voice were employed to implement to sets of recordings, where each recording has a 20-second duration. FIG. 10 presents a sample signal of the recorded data that was used to train the voice signature recognition algorithm.

Each of the recorded 20-second audio clip (for male and female user) were augmented by adding background noise. Background noise is an important concept in setting noise levels. The background noises represent an environmental noise such as multi-speaker speech, water waves, alarms, traffic noise, noise from animals, noise from electronic devices such as, mobile phones, air conditioning, power supplies, refrigerators, and motors. The resulting data was 200 samples for each user, and the duration of each sample was 20 seconds. The feature extraction is based on computing Mel-Frequency Cepstral Coefficients (MFCCs) for a 20-second recoded voice clips. MFCCs are coefficients that collectively make up a Mel-frequency spectrum. These coefficients are constructed from a type of a Cepstral form of the audio clip called spectrum-of-a-spectrum. The MFCCs are the amplitudes of the resulting spectrum. There can be variations on this process, for illustration a difference in the shape or spacing of the windows used to map the scale, or addition of dynamics features such as first- and second-order frame-to-frame difference coefficients. Spectrum is the result of calculating the Inverse Fourier Transform (IFT). The difference between the Mel-frequency spectrum and the spectrum is that in the Mel-frequency spectrum (which is the frequency bands) are equally spaced within the Mel scale, which provides approximation of the tone of the human auditory system. This approximation provides a more accurate simulation for the human tone than the linearly spaced frequency bands used in the normal spectrum. This significant frequency deformation enables better representation of the auditory system; for instance, in audio compression that might theoretically reduce the transmission bandwidth and the storage requirements of audio signals.

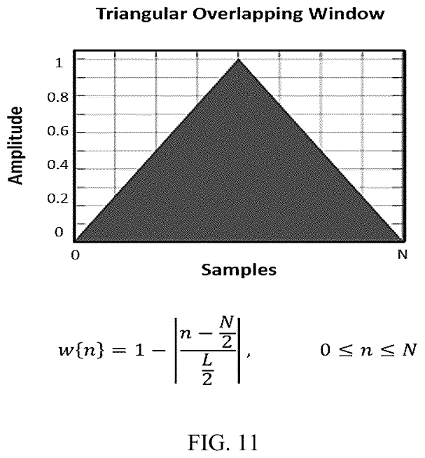

MFCCs are frequently derived by originally taking the Fourier transform of a windowed segment of the auditory signal and mapping the powers of the spectrum obtained onto the Mel using triangular overlapping windows. On the other hand, cosine overlapping windows is an alternative option for mapping the powers of the spectrum. The triangular overlapping windows window offers the triangular-shaped weighting function but does not bring the wave to zero at the edges of each window in the signal. It decreases spectral distortion, provides more classifiable information for the processed signal, and eliminates cutoffs at the edges of the frames. FIG. 11 presents the triangular overlapping window. The triangular window is the 2nd-order B-spline window. L is a positive integer with can be equal to N, N+1, N+2. The L=N form can be seen as the convolution of two N2-width rectangular windows. The Fourier transform of the result is the squared values of the transform of the half-width rectangular window.

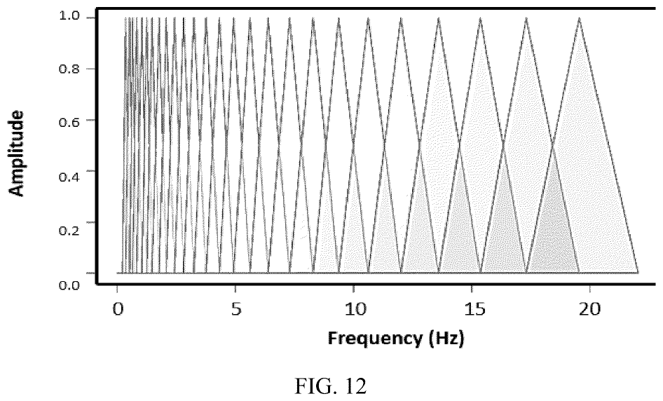

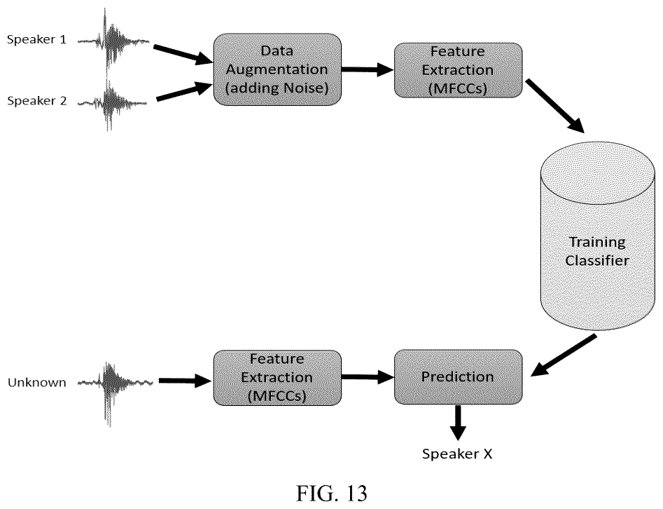

Then, the logs of the powers at each of the Mel frequencies were calculated and the discrete cosine transformation of the list of Mel log powers was obtained as if it were a signal. One methodology to simulate the spectrum is to employ a filter bank. One filter for each anticipated Mel-frequency module was used. That filter bank has a frequency response work through triangular band-pass filter as well. FIG. 12 shows the filter banks on Mel frequency scale. The designed algorithm used the obtained MFCC to extract the features from the recorded voice. Then the system used vector quantization to create a codebook and classify the speaker based on the codebook. By calculating the inverse FFT of the logarithm of the magnitude spectrum and converting it back to time, Applicants obtain the MFCCs for each sample that represents the characteristics of the speaker. The MFCCs for each speaker were later compared with the voice sample recorded in the testing phase to decide the identity of the speaker. Eight voice commands were used in the recorded sample for the testing phase. The designed model accomplished 100% accuracy in identifying each of the two users (male and female) using only 4 seconds of their recorded voice. FIG. 13 illustrates the architecture of the speaker identity verification model.

The disclosed methodologies offers many advantages over conventional methodologies including, but not limited to: lower cost equipment, less complex data sets to process, and superior accuracy for determining inner speech.

Now, therefore, the following is claimed:

1. An internalized speech recognition method using at least one signal comprising the steps of:
placing at least one electrode on an individual;
collecting data from the individual using the at least one electrode;
preprocessing the collected data, wherein the preprocessing comprises noise attenuation and calibration;
extracting features from the collected data using at least one feature extraction method; and
classifying the features using supervised learning using a machine learning algorithm.

2. The method of claim 1, wherein the data is EEG data and wherein the noise attenuation and calibration comprises the step of applying a bandpass filter between 10 and 100 Hz to eliminate noise.

3. The method of claim 1, wherein the data is ECG data and wherein the noise attenuation and calibration comprises the steps of applying a 4th order Butterworth bandpass filter with 0.5 Hz to 150 Hz bandwidth, applying a notch filter at 60 Hz, and applying a high-pass filter with a cut-off frequency of 0.5 Hz.

4. The method of claim 1, wherein the method further comprises presenting an audio or visual prompt to the individual prior to collecting data.

5. The method of claim 3, wherein the electrodes are placed on the left side of the individual's forehead, the right side of the individual's forehead, and on the individual's left side below the neck.

6. The method of claim 1, wherein the at least one feature extraction method is selected from the group consisting of: autoregressive coefficient (AR), Shannon entropy, fractal measures, and multiscale wavelet variance estimation.

7. The method of claim 1, wherein the at least one feature extraction method comprises autoregressive coefficient (AR), Shannon entropy, fractal measures, and multiscale wavelet variance estimation.

8. The method of claim 1, wherein the machine learning algorithm is SVM.

9. The method of claim 1, wherein the individual has been diagnosed with or suspected of having a speech disorder.

10. The method of claim 1, wherein the features are classified using a predetermined set of words.

11. The method of claim 1, comprising an additional step of controlling a vehicle using the classified features.

12. An internalized speech recognition method using at least one signal comprising the steps of:
placing at least one electrode on an individual;
collecting data from the individual using the at least one electrode;
preprocessing the collected data, wherein the preprocessing comprises noise attenuation and calibration;
extracting features from the collected data using at least one feature extraction method, wherein the at least one feature extraction method is selected from the group consisting of: autoregressive coefficient (AR), Shannon entropy, fractal measures, and multiscale wavelet variance estimation; and
classifying the features using supervised learning using a machine learning algorithm, wherein the machine learning algorithm is SVM.

13. The method of claim 12, wherein the collected data is EEG data and wherein the noise attenuation and calibration comprises the step of applying a bandpass filter between 10 and 100 Hz to eliminate noise.

14. The method of claim 12, wherein collected data is ECG data and wherein the noise attenuation and calibration comprises the steps of applying a 4th order Butterworth bandpass filter with 0.5 Hz to 150 Hz bandwidth, applying a notch filter at 60 Hz, and applying a high-pass filter with a cut-off frequency of 0.5 Hz.

15. The method of claim 12, wherein the method further comprises presenting an audio or visual prompt to the individual prior to collecting data.

16. The method of claim 13, wherein the electrodes are placed on the left side of the individual's forehead, the right side of the individual's forehead, and on the individual's left side below the neck.

17. The method of claim 12, wherein the individual has been diagnosed with or suspected of having a speech disorder.

18. The method of claim 12, wherein the features are classified using a predetermined set of words.

19. The method of claim 12, comprising an additional step of controlling a vehicle using the classified features.

20. An internalized speech recognition method using a multimodal signal comprising the steps of:
placing at least one electrode on an individual;
collecting data from the individual using the at least one electrode, wherein the collected data comprises ECG data and EEG data;
preprocessing the collected data, wherein the preprocessing comprises noise attenuation and calibration;
extracting features from the collected data using at least one feature extraction method, wherein the at least one feature extraction method is selected from the group consisting of: autoregressive coefficient (AR), Shannon entropy, fractal measures, and multiscale wavelet variance estimation; and
classifying the features using supervised learning using a machine learning algorithm, wherein the machine learning algorithm is SVM.
